(19) United States
(12) Patent Application Publication
(10) Pub. No.: US 2003/0137505 A1
(43) Pub. Date: Jul. 24, 2003

(54) Apparatus for and method of generating triangular patch representing facial characteristics and computer readable recording medium having processing program for generating triangular patch representing facial characteristics recorded thereon

(76) Inventors: Naoya Ishikawa, Hirakata City (JP); Hiroyasu Koshimizu, Nagoya City (JP); Takayuki Fujiwara, Nagoya City (JP)

Correspondence Address: RADER FISHMAN & GRAUER PLLC, LION BUILDING, 1233 20TH STREET N.W., SUITE 501, WASHINGTON, DC, 20036, US

(21) Appl. No.: 10/293,984

(22) Filed: Nov. 14, 2002

(30) Foreign Application Priority Data
Jan. 23, 2002 (JP) 2002-014806

(51) Int. Cl. G06T 15/00

(52) U.S. Cl. 345/419

(57) ABSTRACT

An apparatus for generating triangular patches comprises triangular patch generation means for extracting characteristic points in a face on the basis of data representing the three-dimensional shape of the face and generating a plurality of triangular patches using the extracted characteristic points, and correction means for extracting the characteristic points in a required portion of the face on the basis of image data related to the face and correcting the triangular patches on the basis of the extracted characteristic points.

### BACKGROUND OF THE INVENTION

1. Field of the Invention

The present invention relates to an apparatus for generating triangular patches representing facial characteristics, a method of generating triangular patches representing facial characteristics, and a computer readable recording medium having a processing program for generating triangular patches representing facial characteristics recorded thereon.

2. Description of the Prior Art

The inventors of the present invention have developed a method of generating data representing the three-dimensional shape of a face from images of the face picked up by digital cameras, extracting characteristic points from the data representing the three-dimensional shape of the face, and deforming the characteristic points to generate a three-dimensional portrait.

First, using a three-dimensional shape measuring apparatus having a plurality of digital cameras arranged on the peripheral surface of a circular cylinder or an elliptic cylinder surrounding a subject, the head (face) of a person is imaged over its circumference. That is, the person is positioned at an equal distance from the plurality of digital cameras arranged on the peripheral surface of the circular cylinder or the elliptic cylinder surrounding a subject. The three-dimensional shape measuring apparatus accepts information related to the color of the circumference and the concavity or convexity of the head by normal imaging and light irradiation imaging, to generate data representing the three-dimensional shape of the head by a hybrid method using both a silhouette (contour) method and an active multiple-eye stereo method (pattern light irradiation).

Characteristic points such as the eyes, the nose, and the mouth are automatically extracted from three-dimensional data (X, Y, and Z coordinate values) related to the face, to generate triangular patches using the characteristic points. A three-dimensional portrait is generated on the basis of the triangular patches.

Specifically, the triangular patch corresponding to the mean face is previously generated from data related to a plurality of persons. Let S be the triangular patch corresponding to the mean face. When the triangular patch S corresponding to the mean face is subtracted from a triangular patch P corresponding to the face of the particular person, an individual portion of the person is extracted. When the individual portion is multiplexed by an exaggeration factor b, to make individuality outstanding, and is overlapped with the original triangular patch P, a deformed portrait Q can be generated (Equation (1)):

Q=P+b(P−S) (1)

Meanwhile, the characteristic points in the face are extracted on the basis of only the data representing the three-dimensional shape of the face. Therefore, in the triangular patches generated in a region of the eye (the left eye in this example) using the characteristic points, the triangular patch is generated so as to cover the eye, as shown in FIG. 7a. Further, in the triangular patches generated in a mouth region using the characteristic points, the triangular patches are respectively generated so as to cover an upper part and a lower part of the mouth, as shown in FIG. 8a.

When the portrait is generated, therefore, the slant of the eye, the curvature of the mouth, etc. cannot be exaggerated.

### SUMMARY OF THE INVENTION

An object of the present invention is to provide an apparatus for and a method of generating triangular patches representing facial characteristics, in which in a case where a portrait is generated, the slant of the eye, the curvature of the mouth, etc. can be exaggerated, and a computer readable recording medium having a processing program for generating triangular patches representing facial characteristics recorded thereon.

In an apparatus for generating triangular patches representing facial characteristics, the invention as set forth in the claim 1 is characterized by comprising triangular patch generation means for extracting characteristic points in a face on the basis of data representing the three-dimensional shape of the face and generating a plurality of triangular patches using the extracted characteristic points; and correction means for extracting the characteristic points in a required portion of the face on the basis of image data related to the face and correcting the triangular patches on the basis of the extracted characteristic points.

In the apparatus for generating triangular patches representing facial characteristics as set forth in the claim 1, the invention as set forth in the claim 2 is characterized in that the correction means respectively extracts the right and left ends of the eye as the characteristic points on the basis of the image data related to the face and corrects the triangular patch corresponding to an eye region on the basis of the extracted characteristic points.

In the apparatus for generating triangular patches representing facial characteristics as set forth in the claim 1, the invention as set forth in the claim 3 is characterized in that the correction means respectively extracts the right, the left, and the center of the upper contour of the upper lip and the right, the left, and the center of the lower contour of the lower lip as characteristic points on the basis of the image data related to the face and corrects the triangular patch corresponding to a mouth region on the basis of the extracted characteristic points.

In the apparatus for generating triangular patches representing facial characteristics as set forth in the claim 1, the invention as set forth in the claim 4 is characterized in that the correction means comprises means for respectively extracting the right and left ends of the eye as the characteristic points on the basis of the image data related to the face and correcting the triangular patch corresponding to an eye region on the basis of the extracted characteristic points, and means for respectively extracting the right, the left, and the center of the upper contour of the upper lip and the right, the left, and the center of the lower contour of the lower lip as characteristic points on the basis of the image data related to the face and correcting the triangular patch corresponding to a mouth region on the basis of the extracted characteristic points.

In a method of generating triangular patches representing facial characteristics, the invention as set forth in the claim 5 is characterized by comprising a triangular patch generation step for extracting characteristic points in a face on the basis of data representing the three-dimensional shape of the face and generating a plurality of triangular patches using the extracted characteristic points; and a correction step for extracting the characteristic points in a required portion of the face on the basis of image data related to the face and correcting the triangular patches on the basis of the extracted characteristic points.

In the apparatus for generating triangular patches representing facial characteristics as set forth in the claim 5, the invention as set forth in the claim 6 is characterized in that the correction step comprises the step of respectively extracting the right and left ends of the eye as the characteristic points on the basis of the image data related to the face and correcting the triangular patch corresponding to an eye region on the basis of the extracted characteristic points.

In the method of generating triangular patches representing facial characteristics as set forth in the claim 5, the invention as set forth in the claim 7 is characterized in that the correction step comprises the step of respectively extracting the right, the left, and the center of the upper contour of the upper lip and the right, the left, and the center of the lower contour of the lower lip as characteristic points on the basis of the image data related to the face and correcting the triangular patch corresponding to a mouth region on the basis of the extracted characteristic points.

In the method of generating triangular patches representing facial characteristics as set forth in the claim 5, the invention as set forth in the claim 8 is characterized in that the correction step comprises the step of respectively extracting the right and left ends of the eye as the characteristic points on the basis of the image data related to the face and correcting the triangular patch corresponding to an eye region on the basis of the extracted characteristic points, and the step of respectively extracting the right, the left, and the center of the upper contour of the upper lip and the right, the left, and the center of the lower contour of the lower lip as characteristic points on the basis of the image data related to the face and correcting the triangular patch corresponding to a mouth region on the basis of the extracted characteristic points.

In a computer readable recording medium having a processing program for generating triangular patches representing facial characteristics recorded thereon, the invention as set forth in the claim 9 is characterized in that the processing program for generating the triangular patches representing facial characteristics so as to carry out a triangular patch generation step for extracting characteristic points in a face on the basis of data representing the three-dimensional shape of the face and generating a plurality of triangular patches using the extracted characteristic points; and a correction step for extracting the characteristic points in a required portion of the face on the basis of image data related to the face and correcting the triangular patches on the basis of the extracted characteristic points.

In the computer readable recording medium having a processing program for generating triangular patches representing facial characteristics recorded thereon as set forth in the claim 9, the invention as set forth in the claim 10 is characterized in that the correction step comprises the step of respectively extracting the right and left ends of the eye as the characteristic points on the basis of the image data related to the face and correcting the triangular patch corresponding to an eye region on the basis of the extracted characteristic points.

In the computer readable recording medium having a processing program for generating triangular patches representing facial characteristics recorded thereon as set forth in the claim 9, the invention as set forth in the claim 11 is characterized in that the correction step comprises the step of respectively extracting the right, the left, and the center of the upper contour of the upper lip and the right, the left, and the center of the lower contour of the lower lip as characteristic points on the basis of the image data related to the face and correcting the triangular patch corresponding to a mouth region on the basis of the extracted characteristic points.

In the computer readable recording medium having a processing program for generating triangular patches representing facial characteristics recorded thereon as set forth in the claim 9, the invention as set forth in the claim 12 is characterized in that the correction step comprises the steps of respectively extracting the right and left ends of the eye as the characteristic points on the basis of the image data-related to the face and correcting the triangular patch corresponding to an eye region on the basis of the extracted characteristic points, and respectively extracting the right, the left, and the center of the upper contour of the upper lip and the right, the left, and the center of the lower contour of the lower lip as characteristic points on the basis of the image data related to the face and correcting the triangular patch corresponding to a mouth region on the basis of the extracted characteristic points.

The foregoing and other objects, features, aspects and advantages of the present invention will become more apparent from the following detailed description of the present invention when taken in conjunction with the accompanying drawings.

### BRIEF DESCRIPTION OF THE DRAWINGS

FIG. 1 is a block diagram showing the configuration of a portrait generating apparatus;

FIG. 2 is a flow chart showing the procedure for processing for generating the mean face;

FIG. 3 is a schematic view showing a system coordinate system;

FIG. 4 is a schematic view for explaining a method of estimating the Y-axis in the system coordinate system;

FIG. 5 is a schematic view showing characteristic points and triangular patches set on the front side of a face;

FIG. 6 is a schematic view showing characteristic points and triangular patches set on the rear side of the face;

FIGS. 7a and 7b are schematic views for explaining a method of correcting a triangular patch corresponding to an eye region;

FIGS. 8a and 8b are schematic views for explaining a method of correcting a triangular patch corresponding to a mouth region;

FIG. 9 is a flow chart showing the procedure for processing for generating a portrait; and

FIGS. 10a and 10b are schematic views for explaining a method of deforming vertex data in each of polygon data related to an input face on the basis of a triangular patch corresponding to a portrait.

### DESCRIPTION OF THE PREFERRED EMBODIMENTS

Description is now made of an embodiment of the present invention.

[1] Description of Overall Configuration of Three-dimensional Portrait Generating Apparatus

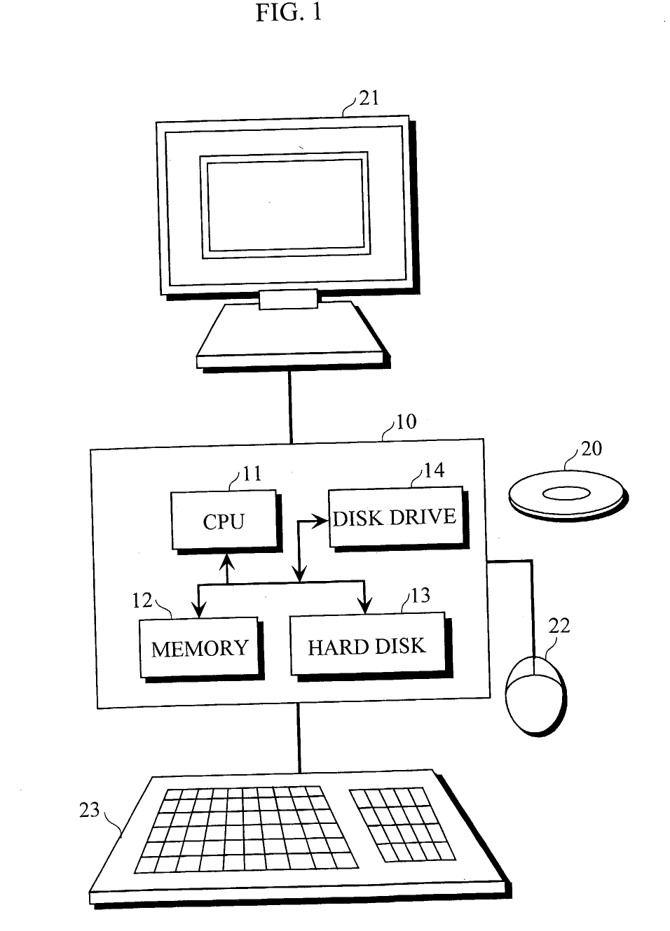

FIG. 1 illustrates the configuration of a three-dimensional portrait generating apparatus.

The three-dimensional portrait generating apparatus is realized by a personal computer. A display (monitor) 21, a mouse 22, and a keyboard 23 are connected to a personal computer 10. The personal computer 10 comprises a CPU 11, a memory 12, a hard disk 13, and a drive (disk drive) 14 for a removable disk such as a CD-ROM.

The hard disk 13 stores a three-dimensional portrait generation processing program in addition to an OS (Operating System) or the like. The three-dimensional portrait generation processing program is installed in the hard disk 13 using a CD-ROM 20 storing the program. Further, the hard disk 13 shall previously store polygon data related to the circumferences of the heads of a plurality of persons for generating the mean face (hereinafter referred to as polygon data for generating the mean face) and color image data for each of polygons constituting the polygon data, and polygon data related to the circumference of the head of a person forming the basis of a portrait to be generated (hereinafter referred to as polygon data related to the input face) and color image data for each of polygons constituting the polygon data. In the present embodiment, polygon data related to three vertexes are used as the polygon data.

The polygon data (NFF data) related to the circumference of the head of the person and the color image data for each of the polygons are generated by a three-dimensional shape measuring apparatus comprising a plurality of digital cameras arranged on the peripheral surface of a circular cylinder or an elliptic cylinder surrounding a subject or subjects. That is, the person is positioned at an equal distance from the plurality of digital cameras arranged on the peripheral surface of the circular cylinder or the elliptic cylinder surrounding a subject or subjects. The three-dimensional shape measuring apparatus accepts imaging data related to the circumference of the head by normal imaging and light irradiation imaging, to generate polygon data and color image data for each of the polygons constituting the polygon data on the basis of the accepted imaging data. [2] Description of Procedure for Processing for Generating Three-dimensional Portrait Based on Three-dimensional Portrait Generation Processing Program Examples of three-dimensional portrait generation processing include mean face generation processing performed as preliminary processing and portrait generation processing.

[2-1] Description of Mean face Generation Processing

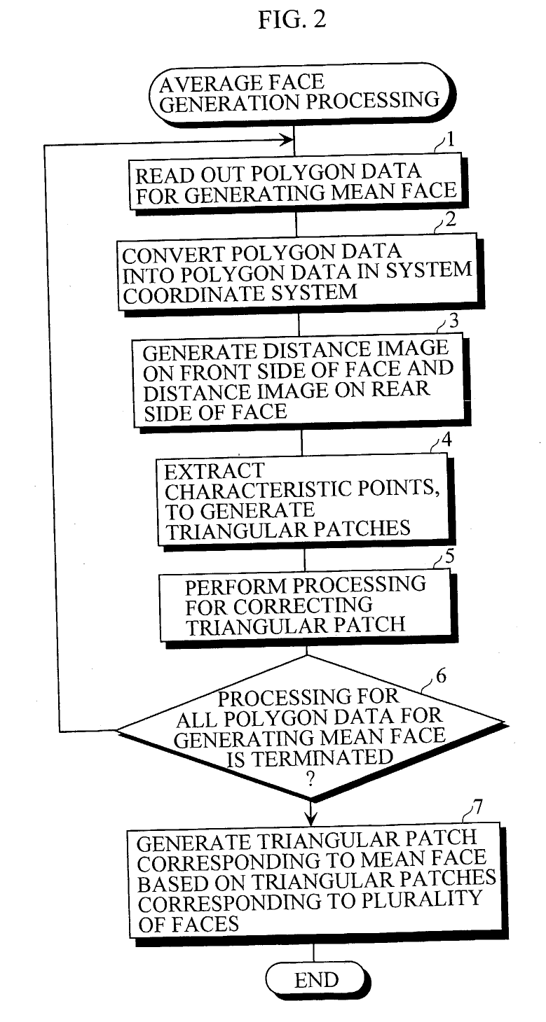

FIG. 2 shows the procedure for processing for generating the mean face.

(i) Polygon data for generating the mean face corresponding to one person is read out of polygon data for generating the mean face corresponding to a plurality of persons stored in the hard disk 13 (step 1).

(ii) The read polygon data for generating the mean face is converted into polygon data in a system coordinate system (step 2).

The system coordinate system is defined by taking an approximately vertical plane passing through both the ears as an X-Y plane, taking a perpendicular from a nose vertex to the X-Y plane as the Z-axis, taking the intersection of the Z-axis and the X-Y plane as the origin, taking an axis passing through the origin in the X-Y plane and extending rightward and leftward in the face as the X-axis, and taking an axis passing through the origin in the X-Y plane and extending upward and downward in the face as the Y-axis.

Description is made of a coordinate system including the polygon data obtained from the three-dimensional shape measuring apparatus (a coordinate system in the three-dimensional shape measuring apparatus). A vertical line passing through a position equally spaced from the plurality of digital cameras arranged on the peripheral surface of the circular cylinder or the elliptic cylinder surrounding a subject or subjects is set to the Y-axis. The X-axis and the Z-axis are set at right angles to the Y-axis. When a person is imaged by the three-dimensional shape measuring apparatus, the person is positioned at an equal distance from the plurality of digital cameras arranged on the peripheral surface of the circular cylinder or the elliptic cylinder surrounding a subject or subjects, and the direction of the face of the person is adjusted such that the face of the person is directed toward the plus side of the Z-axis. The position at the height of the origin is set to a position near the center at the height of the face of the person at the time of imaging.

Description is made of the procedure for processing for converting the polygon data into the polygon data in the system coordinate system.

\mathring{1} As shown in FIG. 4, a straight line Lo corresponding to the axis of the head is first found. The straight line Lo is found, by taking the respective centers of gravity of data representing the three-dimensional shape separated by an arbitrary number of (a plurality of) X-Y planes in the coordinate system in the three-dimensional shape measuring apparatus as a point sequence, as a straight line whose total distance from the point sequence is the smallest.

The polygon data is subjected to conversion for taking the found straight line Lo as the Y-axis. The conversion is performed by rotation and parallel translation for taking the straight line Lo as the Y-axis. Unknown parameters such as the origin in the system coordinate system are matched with parameters in the coordinate system in the three-dimensional shape measuring apparatus.

\mathring{2} The polygon data converted in the foregoing item \mathring{1} is rotated by combining rotation centered around the X-axis and rotation centered around the Z-axis in the coordinate system in the three-dimensional shape measuring apparatus, to find the position where the sum of the minimum distances from all vertex data to the Y-axis defined in the item \mathring{1} is the smallest.

The Y-axis at this position is the Y-axis in the system coordinate system. The conversion performed herein is rotation centered around the X-axis and rotation centered around the Z-axis.

\mathring{3} Assuming that the Z-axis in the coordinate system in the three-dimensional shape measuring apparatus is the same in direction as the Z-axis in the system coordinate system, a point at which a value to the Z-axis is the maximum is taken as a nose vertex. The polygon data converted in the item \mathring{2} is converted such that the intersection of the Y-axis in the system coordinate system defined in the item \mathring{2} and a perpendicular from the nose vertex to the Y-axis is the origin O in the system coordinate system. The conversion is performed by parallel translation of the value of Y (the y-coordinate) The polygon data in the coordinate system in the three-dimensional shape measuring apparatus is converted into the polygon data in the system coordinate system by the conversions in the foregoing items \mathring{1}, \mathring{2}, and \mathring{3}. An X-Y plane having the Y-axis as a normal vector and passing through the origin O is found.

In the following steps, the polygon data indicates the polygon data in the system coordinate system.

(iii) A distance image (a depth map) on the front side of the face and a distance image (a depth map) on the rear side of the face are then generated on the basis of the polygon data for generating the mean face (step 3).

The distance image on the front side of the face is an image having as a distance value z generated from data satisfying z>0 out of the vertex data (x, y, z) in the polygon data for generating the mean face. The distance image on the rear side of the face is an image having as a distance value z generated from data satisfying z<0 out of the vertex data in the polygon data for generating the mean face.

(iv) A plurality of characteristic points are then extracted on the basis of the distance image on the front side of the face and the distance image on the rear side of the face, to generate a plurality of triangular patches each having the characteristic points as vertexes (step 4).

In the present embodiment, 34 characteristic points are extracted, as shown in FIG. 5, from the front of the face, and 10 characteristic points are extracted, as shown in FIG. 6, from the rear of the face. When the characteristic points are the points as shown in FIGS. 5 and 6, triangular patches are as shown in FIGS. 5 and 6. In this example, 82 triangular patches are generated.

Description is now made of a method of extracting characteristic points.

A portion, whose distance value is the highest, of the distance image on the front side of the face is first extracted as a nose vertex P30.

Local polar points are extracted by scanning the gradient of the distance value upward and downward from the nose vertex P30. On the upper side of the nose vertex P30, two points, i.e., the lowest portion yᵤₗ of the ridge of the nose and the forehead yᵤ₂ (P26) are extracted. On the lower side of the nose vertex P30, a total of five points, i.e., the lowest portion y_{b1} (P32) of the ridge of the nose and four points y_{b2}, y_{b3}, y_{b4}, and y_{b5} corresponding to the concavity or convexity of the mouth. A nose region, an eye region, and a mouth region are extracted using characteristic points along the Y-axis.

The nose region is found in the following manner. The gradient of the distance value is scanned rightward and leftward from the nose vertex P30, to determine positions at a left end and a right end of the nose region by threshold processing. A middle point y_{u0.5} (P28) of the polar point yᵤ₁ and the nose vertex P30 is taken as a position at an upper end of the nose region, and the polar point y_{b1} (P32) is taken as a position at a lower end of the nose region. That is, a square region having points P31, P27, P29, and P33 as vertexes is defined as the nose region, and the characteristic points P27 to P33 are arranged in the nose region.

The eye region is found in the following manner. The polar point yᵤ₂ is taken as a position at an upper end of the eye region, and the above-mentioned middle point y_{u0.5} is taken as a position at a lower end of the eye region. The gradient of the distance value is scanned rightward and leftward in the face from each of the two points, to determine positions at a left end and a right end which respectively correspond to the upper end and the lower end of the eye region by threshold processing. That is, a square region having points P22, P24, P10, and P12 as vertexes is defined as the eye region. Further, a middle point between the characteristic points P22 and P24 is set as a characteristic point P23, and a middle point between the characteristic points P10 and P12 is set as a characteristic point P11. Consequently, the characteristic points P10, P11, P12, P22, P23, P24, and P26 are arranged in the eye region.

The mouth region is found in the following manner. The polar point y_{b2} is taken as a position at an upper end of the mouth region, and the polar point y_{b5} is taken as a position at a lower end of the mouth region. The gradient of the distance value is scanned rightward and leftward in the face from each of the two points, to determine positions at a left end and a right end which respectively correspond to the upper end and the lower end of the eye region by threshold processing. That is, a square region having points P36, P34, P35, and P38 as vertexes is defined as the eye region, and the characteristic points P34 to P38 are arranged in the mouth region.

The gradient of the distance value is then scanned radially from the nose vertex P30 to perform threshold processing, thereby extracting characteristic points in the chin. In this example, the nose vertex P30 is taken as the origin to scan (in the direction of scanning in parentheses) the X-axis (the direction of scanning from the origin: ±x), the Y-axis (−y), y=x (−x), y−x (+x), y=2x (−x), y=−2x (+x) y=x/2 (−x), y=x/2 (+x), thereby extracting characteristic points P13 to P21 in the chin.

The gradient of the distance value is scanned in the direction of the Y-axis (−y) by taking the nose vertex P30 as the origin to perform threshold processing, thereby extracting a characteristic point P5 in the throat.

The gradient of the distance value is scanned in the directions of the Y-axis (+y), y=2x (+x), and y=−2x (−x) by taking the nose vertex P30 as the origin to perform threshold processing, thereby extracting characteristic points P8, P9, and P25 in the head.

Furthermore, the gradient of the distance value is scanned in the directions of y=x (+x) and y=−x (−x) by taking the nose vertex P30 as the origin to perform threshold processing, thereby extracting a characteristic point P2 at the left of the front hair and a characteristic point P0 at the right of the front hair.

Description is now made of the characteristic points on the rear side of the face. A point P39 is the same in x-y coordinates as the characteristic point P26 in the forehead. Further, a point P40 is the same in x-y coordinates as the nose vertex P30. Points P3 and P7 are extracted by scanning the gradient of the distance value in the distance image on the rear side rightward and leftward by taking the point P40 as the origin to perform threshold processing.

A point P41 is arranged by taking the middle point between the point P20 and the point P14 as the value of y. Points P4 and P6 are extracted by scanning the gradient of the distance value rightward and leftward from the value of y which is the middle point between the point P15 and the point P19 to perform threshold processing.

A point P1, a point P42, and a point P43 are extracted by respectively scanning the gradient of the distance value from the point P40 to the Y-axis (−y), y=−2x (−x), and y=2x (+x) to perform threshold processing.

A triangular patch on the front side and a triangular patch on the rear side are coupled to each other by connecting predetermined characteristic points to each other.

(v) Processing for correcting triangular patches is then performed (step 5).

In the triangular patches generated in the foregoing step 4, the triangular patch is generated so as to cover the eye, as shown in FIG. 7a. Further, the triangular patches are respectively generated so as to cover an upper part and a lower part of the mouth, as shown in FIG. 8a.

In the portrait, therefore, the slant of the eye, the curvature of the mouth, etc. cannot be exaggerated. In the step 5, therefore, the triangular patches respectively corresponding to the eye region and the mouth region are corrected, as shown in FIGS. 7b and 8b, such that the slant of the eye, the curvature of the mouth, etc. can be exaggerated. The correction processing will be described.

Color image data corresponding to a person currently processed (three-dimensional color image data in a polygon) is first read out of the hard disk 13. Data on the front side of the face in the read three-dimensional color image data is expanded, to generate two-dimensional color image data. The triangular patches respectively corresponding to the eye region and the mouth region are set more finely using the two-dimensional color image data as a basis.

Description is first made of processing for correcting triangular patches corresponding to the eye region. The contour of the left eye is extracted on the basis of the two-dimensional color image data. Points at rightmost and leftmost ends of the extracted contour of the left eye are set as characteristic points PLa and PLb. Characteristic points P29, P26, P10, P12, PLa and PLb are used, as shown in FIG. 7b, to generate six triangular patches corresponding to a left eye region. Consequently, the number of triangular patches corresponding to the left eye region is increased from three to six. Consequently, it is possible for the system to recognize slant eyes, drooping eyes, etc.

The characteristic point P11 is deleted. Consequently, the number of characteristic points in the left eye region is increased by one. Since the characteristic point P11 is deleted, a triangular patch having as vertexes the characteristic points P11, P10, and P2 is changed to a triangular patch having as vertexes the characteristic points P12, P10, and P2. The same processing is also performed with respect to the right eye, thereby changing the triangular patches.

Description is made of processing for changing triangular patches corresponding to the mouth region. The contour of the mouth is extracted on the basis of the two-dimensional color image data. In this case, the contour of the mouth is extracted utilizing the difference between a fresh-colored region and a red component of the mouth. The respective centers of the contours of the upper lip and the lower lip are set as characteristic points PMa and PMb. Eight triangular patches are generated in the mouth region using characteristic points P36, P34, P31, P33, P35, P38, PMa, and PMb, as shown in FIG. 8b. Consequently, the number of triangular patches corresponding to the mouth region is increased from six to eight. Consequently, it is possible for the system to recognize the shape of the mouth including not only the right and left sizes of the mouth but also the length of the mouth (the thickness of the lip) and the curvature of the mouth.

The characteristic points P32 and P37 are deleted. Therefore, the number of characteristic points is unchanged in the mouth region. Since the characteristic points P32 and P37 are deleted, there exist no line connecting P32 and P30 and no line connecting P37 and P17, as shown in FIG. 5. Consequently, the number of triangular patches is increased by two in the mouth region, while the number of triangular patches is decreased by two outside the mouth region.

By the correction processing in the step 5, the number of characteristic points on the front side of the face is increased by two to 36, the number of characteristic points on the rear side of the face remains unchanged from ten, and the number of triangular patches is increased by six to 88.

(vi) The processing in the foregoing steps 1 to 5 is repeated until all the polygon data for generating the mean face, which are stored in the hard disk 13, are subjected to the processing in the foregoing steps 1 to 5, thereby generating triangular patches corresponding to the plurality of polygon data for generating the mean face (step 6).

(vii) When the triangular patches corresponding to a plurality of faces are thus generated, triangular patches corresponding to the mean face are generated on the basis of the generated triangular patches corresponding to the plurality of faces (step 7).

Specifically, the average value of the coordinates (x, y, z) of the vertexes (characteristic points) of each of the triangular patches is calculated on the basis of the following equation (2). A point obtained from the calculated average value of the coordinates (x, y, z) of the vertexes of each of the triangular patches is taken as the characteristic point in the mean face, to generate the triangular patches corresponding to the mean face (an average distance image).

$$\begin{matrix}\begin{matrix}{x}_{( m , j )} = \frac{1}{N} {\sum }_{K = 1}^{N} {x}_{( m , j )}^{( k )} \\ {y}_{( m , j )} = \frac{1}{N} {\sum }_{K = 1}^{N} {y}_{( m , j )}^{( k )}\end{matrix} \\ {z}_{( m , j )} = \frac{1}{N} {\sum }_{K = 1}^{N} {z}_{( m , j )}^{( k )}\end{matrix} \qquad ( 2 )$$

In the foregoing equation (2), m (m=1, 2, . . . 88) indicates a triangular patch, and j (j=1, 2, 3) indicates the vertex of the triangular patch.

x^{(m,j)}^{(k)}, y_{(m,j)}^{(k)}, and z_{(m,j)}^{(k)} respectively indicate the x-coordinate, the y-coordinate, and the z-coordinate of the vertex of each of triangular patches corresponding to the plurality of faces for generating the mean face.

x_{(m,j)}^{(S)}, y_{(m,j)}^{(S)}, and z_{(m,j)}^{(S)} respectively indicate the x-coordinate, the y-coordinate, and the z-coordinate of the vertex of each of triangular patches corresponding to the mean face.

The triangular patches corresponding to the mean face thus obtained are stored in the hard disk 13 as the triangular patches corresponding to the mean face.

[2-2] Description of Portrait Generation Processing

FIG. 9 shows the procedure for processing for generating a portrait.

(i) Polygon data related to the input face stored in the hard disk 13 is read out (step 11).

(ii) The read polygon data related to the input face is converted into polygon data in the system coordinate system (step 12). The processing is the same as the processing in the step 2 shown in FIG. 2 and hence, the description thereof is not repeated.

(iii) A distance image on the front side of the face and a distance image on the rear side of the face are then generated on the basis of the polygon data related to the input face (step 13). The processing is the same as the processing in the step 3 shown in FIG. 2 and hence, the description thereof is not repeated.

(iv) A plurality of characteristic points are then extracted on the basis of the distance image on the front side of the face and the distance image on the rear side of the face, to generate a plurality of triangular patches each having the characteristic points as vertexes (step 14). The processing is the same as the processing in the step 4 shown in FIG. 2 and hence, the description thereof is not repeated.

(v) Processing for correcting triangular patches is then performed (step 15). The processing is the same as the processing in the step 5 shown in FIG. 2 and hence, the description thereof is not repeated.

(vi) Triangular patches corresponding to a portrait are then generated on the basis of the triangular patches corresponding to the input face, the triangular patches corresponding to the mean face, and an exaggeration factor b (step 16).

The triangular patches corresponding to the portrait are calculated on the basis of the following equation (3):

x_{(m,j)}^{(Q)}=x_{(m,j)}^{(P)}+b(x_{(m,j)}^{(P)} −x_{(m,j)}^{(S)})

y_{(m,j)}^{(Q)}=y_{(m,j)}^{(P)}+b(y_{(m,j)}^{(p)}−y_{(m,j)}^{(S)})

z^{(m,j)}^{(Q)}=z_{(m,j)}^{(P)}+b(z_{(m,j)}^{(P)}−(m,j)^{(S)}) (3)

In the foregoing equation (3), m (m=1, 2, . . . 88) indicates a triangular patch, and j (j=1, 2, 3) indicates the vertex of the triangular patch. Further, b indicates an exaggeration factor.

x_{(m,j)}^{(Q)}, y_{(m,j)}^{(Q)}, and z_{(m,j)}^{(Q)} respectively indicate the x-coordinate, the y-coordinate, and the z-coordinate of the vertex of each of the triangular patches corresponding to the portrait.

x(m,j)^{(P)}, y_{(m,j)}^{(P)}, and z_{(m,j)}^{(P)} respectively indicate the x-coordinate, the y-coordinate, and the z-coordinate of the vertex of each of the triangular patches corresponding to the input face.

x_{(m, j)}^{(S)}, y_{(m, j)}^{(S)}, and z_{(m,j)}^{(S)} respectively indicate the x-coordinate, the y-coordinate, and the z-coordinate of the vertex of each of triangular patches corresponding to the mean face.

(vii) Data representing the vertex of each of the polygon data related to the input face is then deformed on the basis of the triangular patches corresponding to the portrait, thereby generating polygon data corresponding to the portrait (step 17).

FIG. 10a illustrates the triangular patch corresponding to the input face and the vertexes of the polygon data, and FIG. 10b illustrates the triangular patch corresponding to the portrait and the vertexes of the polygon data after the deformation.

In FIG. 10, F and F′ respectively indicate the vertexes of the polygon data, and T₁, T₂, and T₃ and T₁′, T₂′, and T₃′ respectively indicate the vertexes of the triangular patches T and T′.

I indicates the intersection of a straight line passing through the origin 0 and F and the triangular patch T (T₁, T₂, T₃). I′ indicates the intersection of a straight line passing through the origin 0 and F′ and the triangular patch T′ (T₁′, T₂′, T₃′)

In the triangular patch corresponding to the input face, the following equation (4) holds:

\vec{T₁I}=α\vec{T₂T₁}+β\vec{T₃T₂} (4)

Furthermore, a straight line OF and a straight line OI are expressed by the following equation (5):

\vec{OF}=γ\vec{OI} (5)

Since T₁, T₂, T₃, and F have already been known, parameters α, β, and γ are found. Consequently, the vertex F of arbitrary polygon data and the corresponding triangular patch T are related to each other by the three parameters a β, and γ.

In the triangular patch corresponding to the portrait, the following equation (6) holds. Accordingly, the intersection I′ of a straight line passing through 0 and F′ and the triangular patch T′ (T₁′, T2′, and T₃′) is found from the following equation (6):

\vec{T₁I′}=α\vec{T₂T₁′}+β\vec{T₃′T₂′} (6)

Furthermore, F′ after the deformation is found on the basis of the following equation (7):

\vec{OF′}=\vec{OI′}/γ (7)

This is calculated with respect to each of the vertexes of the polygon, to generate a portrait.

Although the present invention has been described and illustrated in detail, it is clearly understood that the same is by way of illustration and example only and is not to be taken by way of limitation, the spirit and scope of the present invention being limited only by the terms of the appended claims.

What is claimed is:

1. An apparatus for generating triangular patches representing facial characteristics, comprising:
triangular patch generation means for extracting characteristic points in a face on the basis of data representing the three-dimensional shape of the face and generating a plurality of triangular patches using the extracted characteristic points; and
correction means for extracting the characteristic points in a required portion of the face on the basis of image data related to the face and correcting the triangular patches on the basis of the extracted characteristic points.

2. The apparatus according to claim 1, wherein
the correction means respectively extracts the right and left ends of the eye as the characteristic points on the basis of the image data related to the face and corrects the triangular patch corresponding to an eye region on the basis of the extracted characteristic points.

3. The apparatus according to claim 1, wherein
the correction means respectively extracts the right, the left, and the center of the upper contour of the upper lip and the right, the left, and the center of the lower contour of the lower lip as characteristic points on the basis of the image data related to the face and corrects the triangular patch corresponding to a mouth region on the basis of the extracted characteristic points.

4. The apparatus according to claim 1, wherein
the correction means comprises
means for respectively extracting the right and left ends of the eye as the characteristic points on the basis of the image data related to the face and correcting the triangular patch corresponding to an eye region on the basis of the extracted characteristic points, and
means for respectively extracting the right, the left, and the center of the upper contour of the upper lip and the right, the left, and the center of the lower contour of the lower lip as characteristic points on the basis of the image data related to the face and correcting the triangular patch corresponding to a mouth region on the basis of the extracted characteristic points.

5. A method of generating triangular patches representing facial characteristics, comprising:
a triangular patch generation step for extracting characteristic points in a face on the basis of data representing the three-dimensional shape of the face and generating a plurality of triangular patches using the extracted characteristic points; and
a correction step for extracting the characteristic points in a required portion of the face on the basis of image data related to the face and correcting the triangular patches on the basis of the extracted characteristic points.

6. The method according to claim 5, wherein
the correction step comprises the step of
respectively extracting the right and left ends of the eye as the characteristic points on the basis of the image data related to the face and correcting the triangular patch corresponding to an eye region on the basis of the extracted characteristic points.

7. The method according to claim 5, wherein
the correction step comprises the step of
respectively extracting the right, the left, and the center of the upper contour of the upper lip and the right, the left, and the center of the lower contour of the lower lip as characteristic points on the basis of the image data related to the face and correcting the triangular patch corresponding to a mouth region on the basis of the extracted characteristic points.

8. The method according to claim 5, wherein
the correction step comprises the steps of
respectively extracting the right and left ends of the eye as the characteristic points on the basis of the image data related to the face and correcting the triangular patch corresponding to an eye region on the basis of the extracted characteristic points, and
respectively extracting the right, the left, and the center of the upper contour of the upper lip and the right, the left, and the center of the lower contour of the lower lip as characteristic points on the basis of the image data related to the face and correcting the triangular patch corresponding to a mouth region on the basis of the extracted characteristic points.

9. A computer readable recording medium having a processing program for generating triangular patches representing facial characteristics recorded thereon so as to carry out:
a triangular patch generation step for extracting characteristic points in a face on the basis of data representing the three-dimensional shape of the face and generating a plurality of triangular patches using the extracted characteristic points; and
a correction step for extracting the characteristic points in a required portion of the face on the basis of image data related to the face and correcting the triangular patches on the basis of the extracted characteristic points.

10. The computer readable recording medium according to claim 9, wherein
the correction step comprises the step of
respectively extracting the right and left ends of the eye as the characteristic points on the basis of the image data related to the face and correcting the triangular patch corresponding to an eye region on the basis of the extracted characteristic points.

11. The computer readable recording medium according to claim 9, wherein
the correction step comprises the step of
respectively extracting the right, the left, and the center of the upper contour of the upper lip and the right, the left, and the center of the lower contour of the lower lip as characteristic points on the basis of the image data related to the face and correcting the triangular patch corresponding to a mouth region on the basis of the extracted characteristic points.

12. The computer readable recording medium according to claim 9, wherein
the correction step comprises the steps of
respectively extracting the right and left ends of the eye as the characteristic points on the basis of the image data related to the face and correcting the triangular patch corresponding to an eye region on the basis of the extracted characteristic points, and
respectively extracting the right, the left, and the center of the upper contour of the upper lip and the right, the left, and the center of the lower contour of the lower lip as characteristic points on the basis of the image data related to the face and correcting the triangular patch corresponding to a mouth region on the basis of the extracted characteristic points.
